(19) United States
(12) Patent Application Publication
(10) Pub. No.: US 2016/0345381 A1
(43) Pub. Date: Nov. 24, 2016

(54) METHODS AND APPARATUSES FOR TRANSFER OF DEDICATED CHANNEL RESOURCES

(71) Applicant: NOKIA SOLUTIONS AND NETWORKS OY, Espoo (FI)

(72) Inventors: Vinh VAN PHAN, Oulu (FI); Ling YU, Kauniainen (FI); Kari Veikko HORNEMAN, Oulu (FI)

(21) Appl. No.: 15/114,674

(22) PCT Filed: Jan. 31, 2014
(86) PCT No.: PCT/EP2014/051897

§ 371 Date: Jul. 27, 2016

(51) Int. Cl. H04W 76/06; H04W 72/04; H04W 76/04

(52) U.S. Cl. CPC H04W 76/066; H04W 76/043; H04W 72/042; H04W 72/0413

(57) ABSTRACT

Apparatuses and methods for communication are provided. The solution may include determining the possibility of releasing at least part of the dedicated channel resources used for direct device-to-device communication with a group of user terminals; selecting, from the group, at least one user terminal to which the at least part of the channel resources are transferred; and controlling the transmission of a transfer message to the group of user terminals, the message indicating the at least one user terminal the at least part of the dedicated channel resources are transferred to.

### FIELD

The exemplary and non-limiting embodiments of the invention relate generally to wireless communication systems. Embodiments of the invention relate especially to apparatuses, methods, and computer program products in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

In radio communication networks, such as the Long Term Evolution (LTE) or the LTE-Advanced (LTE-A) of the 3rd Generation Partnership Project (3GPP), network planning comprises the use of common base stations (Node B, eNodeB). User equipment (UE), or a user terminal (UT), may communicate with another UE or UT via the base station(s), for example. Alternatively, it is proposed that the UEs may communicate directly with each other by applying resources dedicated by the network for a device-to-device (D2D) direct communication or proximity services (ProSe) or other proximity-based applications or services. The D2D communication has proven to be network efficient by offloading the traffic processed in the base station(s), for example.

Examples of D2D communications include direct communications in a cluster of proximity devices; autonomous D2D communications in cellular network; grid or group of local machines communicating with each other while performing certain tasks in co-operative way; and advanced cellular device acting as a gateway for a number of low-capability devices or machines to access cellular network. One example of implementation possibilities of proximity-based services or applications in machine-type communications is a cyber-physical system (CPS). In CPS, interconnected devices (sensors, actuators, processors, microcontrollers, etc.) embedded in physical objects may communicate with one another or with communications devices, such as multimedia devices.

When planning communication systems the aim is to utilise available communication resources efficiently. In systems where D2D communication is possible this is a particularly challenging task as there may be several D2D groups utilising same resources in addition to normal cellular communication.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus, as claimed in claim 1.

According to an aspect of the present invention, there is provided an apparatus, as claimed in claim 12.

According to an aspect of the present invention, there is provided a method as claimed in claim 20.

According to an aspect of the present invention, there is provided a method as claimed in claim 31.

According to an aspect of the present invention, there is provided a computer program embodied on a distribution medium as claimed in claim 39.

According to an aspect of the present invention, there is provided a computer program embodied on a distribution medium as claimed in claim 40.

### LIST OF DRAWINGS

Embodiments of the present invention are described below, by way of example only, with reference to the accompanying drawings, in which

FIG. 1 illustrates an example of a communication environment;

FIGS. 2, 3, 4 and 5 are flowcharts illustrating some embodiments of the invention; and

FIG. 6 illustrates an example of an apparatus applying embodiments of the invention.

### DESCRIPTION SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any base station, user terminal (UT), user equipment (UT), corresponding component, and/or to any communication system or any combination of different communication systems that support required functionalities.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN or E-UTRAN), long term evolution (LTE®, known also as E-UTRA), long term evolution advanced (LTE-A®), Wireless Local Area Network (WLAN) based on IEEE 802.11 standard, worldwide interoperability for microwave access (WiMAX), Bluetooth®, personal communications services (PCS) and systems using ultra-wideband (UWB) technology. IEEE refers to the Institute of Electrical and Electronics Engineers. LTE and LTE-A are developed by the Third Generation Partnership Project 3GPP.

In the following, different exemplifying embodiments will be described using, as an example of an access architecture to which the embodiments may be applied, a radio access architecture based on long term evolution advanced (LTE Advanced, LTE-A), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately.

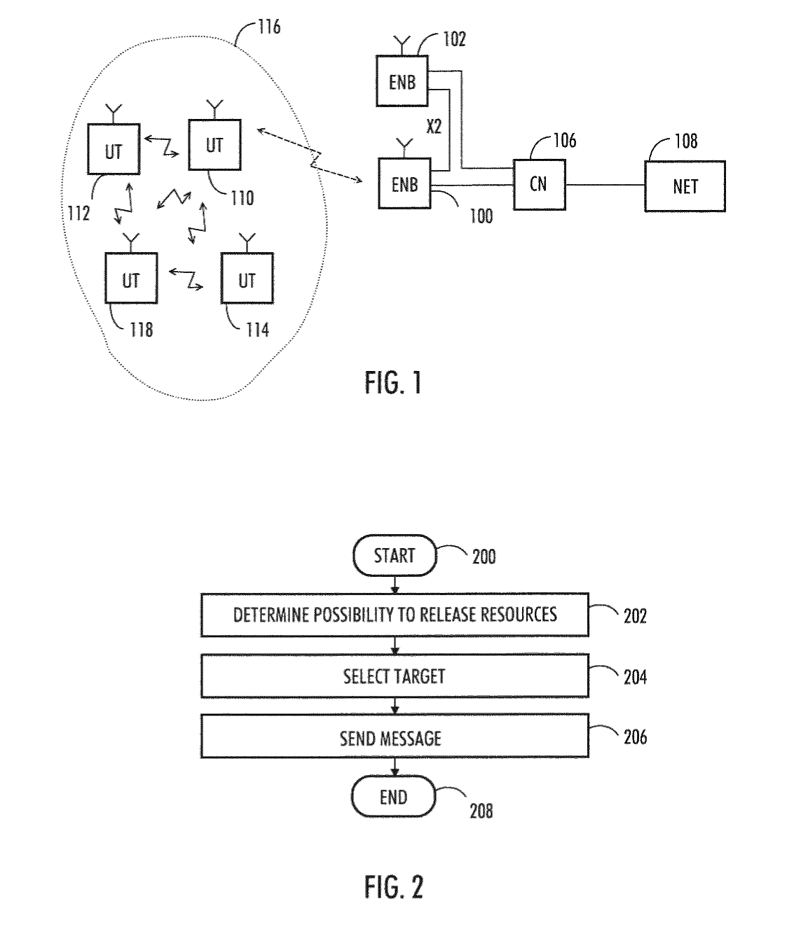

FIG. 1 illustrates a simplified view of an example of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on long term evolution advanced (LTE Advanced, LTE-A) network elements is shown. However, the embodiments described in these examples are not limited to the LTE-A radio systems but can also be implemented in other radio systems.

FIG. 1 shows eNodeBs 100 and 102 connected to core network CN 106 of a communication system. The eNodeBs are connected to each other over an X2 interface.

The eNodeBs 100, 102 that may also be called base stations of the radio system may host the functions for Radio Resource Management: Radio Bearer Control, Radio Admission Control, Connection Mobility Control, Dynamic Resource Allocation (scheduling). Depending on the system, the counterpart on the CN side can be a serving gateway (S-GW, routing and forwarding user data packets), packet data network gateway (P-GW, for providing connectivity of user devices (UEs) to external packet data networks), and/or mobile management entity (MME), etc. The MME (not shown) is responsible for the overall user terminal control in mobility, session/call and state management with assistance of the eNodeBs through which the user terminals may connect to the network.

The communication system is also able to communicate with other networks, such as a public switched telephone network or the Internet 108. The communication network may also be able to support the usage of cloud services. It should be appreciated that eNodeBs or their functionalities may be implemented by using any node, host, server or access point etc. entity suitable for such a usage.

The user terminal UT (also called user device, user equipment, terminal device, etc.) illustrates one type of an apparatus to which resources on the air interface may be allocated and assigned, and thus any feature described herein with a user device may be implemented with a corresponding apparatus, such as a relay node. An example of such a relay node is a layer 3 relay (self-backhauling relay) towards the base station.

The user terminal typically refers to a portable computing device that includes wireless mobile communication devices operating with or without a subscriber identification module (SIM), including, but not limited to, the following types of devices: a mobile station (mobile phone), smartphone, personal digital assistant (PDA), device using a wireless modem (alarm or measurement device, etc.), laptop and/or touch screen computer, tablet, phablet, game console, notebook, and multimedia device. A user terminal may also be a machine-type communications device, such as a sensor, actuator, processor or microcontroller capable to communicate via a radio interface. Additionally, a user terminal may also be a nearly exclusive uplink only device, of which an example is a camera or video camera loading images or video clips to a network.

The user terminal (or in some embodiments a layer 3 relay node) is configured to perform one or more of user equipment functionalities. The device may also be called a subscriber unit, mobile station, remote terminal, access terminal, user equipment (UE) just to mention but a few names or apparatuses.

Further, although the apparatuses have been depicted as single entities, different units, processors and/or memory units (not all shown in FIG. 1) may be implemented.

FIG. 1 shows four user terminals 110, 112, 114 and 118 which are participating in a direct device-to-device communication either as a cluster head, active user or passive user. The user terminals (UTs) form a device-to-device communication group or cluster 116. There may be several D2D groups or clusters in the same area.

In an embodiment it is proposed to utilise a star-topology in a D2D cluster. In such a solution a selected terminal is taking a special role, referred to as the cluster head (CH), in coordinating and perhaps controlling possible D2D communications among cluster members. In an embodiment, a D2D cluster may utilise broadcast based D2D communications between the UTs of the group. The cluster head may coordinate and allocate channel resources for cluster members to transmit for their requested individual user(s) or user group(s) within the cluster. The cluster head CH may coordinate and control resource usage to ensure efficient and fair resource sharing among individual active users and user groups being members of the cluster, taking into account diverse traffic demands and other group/user and service profile characteristics, such as priorities.

In the example of FIG. 1, UT 110 is the cluster head. The cluster head may have a connection with eNodeB 100. However, the D2D may as well operate on areas where the communication system is not available.

In an embodiment, the cluster head may control the operation of more than one cluster, i.e. different clusters of user terminals may have a common cluster head.

In an embodiment, the CH is configured (by itself in autonomous operation or by serving network in network-controlled operation) to form a set of pre-defined radio channel resources which can be used for D2D communication within the cluster. Furthermore, the CH may have a pre-allocated broadcast control channel which can be the same or different from the beaconing channel and used to send control information to cluster members. In the latter case, information about the broadcast control channel of CH is indicated in the beaconing channel so that members can find and listen to that channel. The broadcast control channel of CH may also have a primary-secondary structure for enhancing flexibility and capacity of the broadcast control signalling. For broadcast service, any device which is able to listen to the service may be considered as a member of the cluster. Those members which only listen at a certain time are referred to as passive members. Those who also transmit are referred to as active members. Every UT can be passive member at one time, but be active member in another time due to the half-duplex operation assumption.

The UT members of a D2D group controlled by a CH may transmit resource allocation messages to the CH when they are in need of resources. If resources are available the CH may allocate resources for the UTs.

In an embodiment, a present active user group under control of a CH is assigned a maximum fair share of N channel resources and each active member of the user group may occupy and transmit on at least one of those assigned channels. This means that there can be utmost N active members in the user group in parallel. In the group communication based on 1:M (one to many/multipoint) D2D communication, an active member is supposed to transmit for the rest of the user group. Based on the latest updated broadcast control information of CH, group members are aware of all the N allocated channels of the user group.

There may be a situation in which an active UT member which is having some channel resources allocated to it to transmit for the user group no longer needs the resources due to becoming passive, being turned off or just moving away from the cluster, for example. In an embodiment, it may be beneficial for the user group to hold on to the limited channel resources allocated to it as long as possible for collective needs or uses of the user group, provided that (i) no more resources may be allocated to it by CH due to fair sharing of resources among different present user groups and (ii) if one UT member releases resources to CH and another UE member of the same group requests resources from CH on individual basis in broadcast based group communications of interest may cause a high delay and signalling overhead.

In an embodiment, a self-maintaining of channel resources allocated to a present user group in Layer1 broadcast based 1:M D2D communications is proposed. An active UT member of the user group is allowed to pass or release a part or all of its allocated channel resources to other members within the same user group or intra-group. This enables the user group to hold on to the allocated channel resources for collective needs or uses of the user group. In an embodiment, the proposed scheme comprises messaging between the participants of the group. The messages may be denoted as Intra-Group Channel Release Notification, Intra-Group Channel Transfer Request, and Intra-Group Channel Transfer Response and the messages may be exchanged between the involved parties including the releasing user terminal (i.e. the user terminal member which is trying to release at least a part of its allocated channel resources to other members within the user group), the cluster head (CH), and other members of the user group.

In one embodiment, the possibility of releasing at least part of the dedicated channel resources used for direct device-to-device communication with a group of user terminals is determined, at least one user terminal to which the at least part of the dedicated channel resources are transferred is selected from the group and the transmission of a transfer message to the group of user terminals is controlled, the message indicating the at least one user terminal the at least part of the dedicated channel resources are transferred to.

In another embodiment, the possibility of releasing at least part of the dedicated channel resources used for direct device-to-device communication with a group of user terminals is determined, the transmission of a first message to the group of user terminals indicating that at least part of the dedicated channel resources are releasable is controlled, the reception of responses to the first message from one or more user terminals of the group is controlled, the responses comprising requests for the at least part of the dedicated channel resources, at least one user terminal to which the at least part of the channel resources are transferred is selected from the group based on the responses and the transmission of a transfer message to the group of user terminals is controlled, the message indicating the at least one user terminal the at least part of the dedicated channel resources are transferred to.

In yet another embodiment, the reception of a transfer message targeted to the group of user terminals is controlled, the message indicating that a user terminal is transferring at least part of the dedicated channel resources the user terminal used for direct device-to-device communication with the group of user terminals to at least one other user terminal in the group.

In yet another embodiment, the reception of a first message from a user terminal of the group of user terminals indicating that at least part of the dedicated channel resources the user terminal is using for direct device-to-device communication with the group of user terminals are released is controlled, it is determined, if channel resources for direct device-to-device communication with the group of user terminals are needed; and if so, the transmission of a response to the first message is controlled, the response comprising a request for the releasable dedicated channel resources, and the reception of a transfer message targeted to the group of user terminals is controlled, the message indicating that a user terminal is transferring at least part of the dedicated channel resources the user terminal used for direct device-to-device communication with the group of user terminals to at least one other user terminal in the group.

Embodiments are further clarified below.

FIG. 2 is a flowchart illustrating an embodiment of the invention. The embodiment starts at step 200. The example of FIG. 2 illustrates an example of the operation of user terminal which is in in a direct device-to-device communication or proximity-based communication with a group of user terminals.

In step 202, the user terminal is configured to determine the possibility of releasing at least part of the dedicated channel resources used for direct device-to-device communication with a group of user terminals.

In step 204, the user terminal is configured to select, from the group, at least one user terminal to which the at least part of the channel resources are transferred.

In step 206, the user terminal is configured to control the transmission of a transfer message to the group of user terminals, the message indicating the at least one user terminal the at least part of the channel resources are transferred to. The message may be denoted an Intra-Group Channel Transfer Indication.

The process ends in step 208.

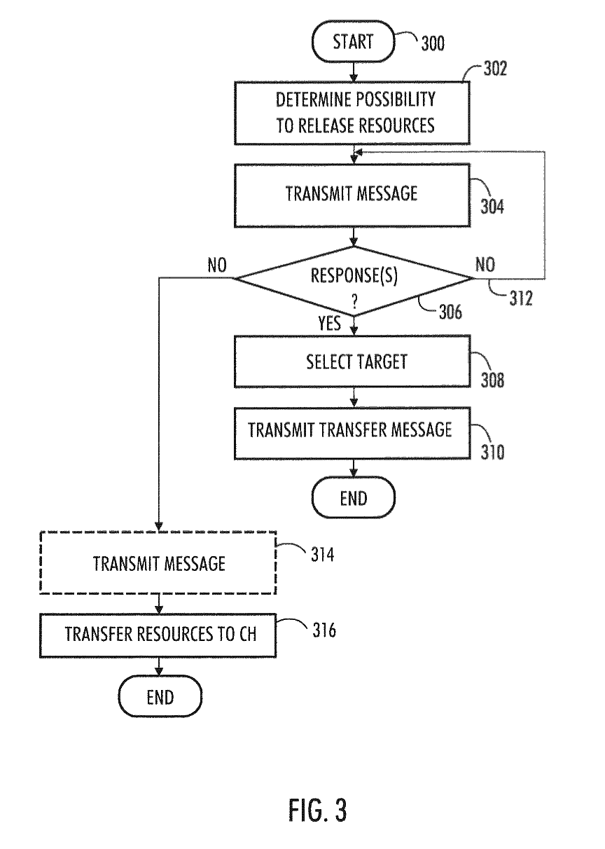

Let us first study further examples of the operation of a UT which is member of a user group conducting D2D group communication under control of a CH and which UT is willing to release all or some of the channel resources dedicated to it. FIG. 3 is a flowchart illustrating some examples. The UT which is able to release resources may be denoted as the releasing user terminal. The embodiment starts at step 300.

In step 302, the releasing user terminal is configured to determine the possibility of releasing at least part of the dedicated channel resources it does not need. Step 302 is the same as step 202 of FIG. 2.

In step 304, the releasing user terminal is configured to control the transmission of a first message to the group of user terminals indicating that at least part of the channel resources may be released. The message may be denoted as an Intra-Group Channel Release Notification and it specifies that the releasing user terminal is willing to pass some particular allocated channel resources to other group members. The message may include e.g. identification (ID) of the releasing user terminal, identification (ID) of the targeted user group, details of the channel resources to be released, and some cause for the release, such as ending of service/application, empty buffer or battery condition. The message may be transmitted on the dedicated channel resources.

In an embodiment, if the message does not specify which particular channel resources are to be released then it is interpreted that the channel resources on which the message is sent are meant for the intended release.

In step 306, the releasing user terminal is configured to control the reception of responses to the first message from one or more user terminals of the group, the responses comprising requests for the at least part of the channel resources. The requests may comprise the ID of the requesting user terminal, and cause for the request (starting/updating of service/application, data buffer information), priority information or other data.

In step 308, the releasing user terminal is configured to select, from the group, on the basis of the responses at least one user terminal to which the channel resources are transferred to. The decision to which UT member(s) a piece or all of the channel resources are transferred to may be based on given rules (passive member may be granted first, user/service priorities, or just first-come-first-serve, for example).

In step 310, the releasing user terminal is configured to control the transmission of a transfer message to the group of user terminals, the message indicating the at least one user terminal the channel resources are transferred to. The message may be denoted as an Intra-Group Channel Transfer Response. The message may include e.g. identification (ID) of the releasing user terminal, identification (ID) of the targeted user group, details of the channel resources to be released, and identifications of the at least one user terminal receiving resources.

The process ends.

In an embodiment, if no responses to the first message are received in a predetermined time interval in step 306, the releasing user terminal is configured to repeat 312 the sending of the first message a predetermined number of times.

In an embodiment, if no responses to the first message are received in a predetermined time interval in step 306, the releasing user terminal is configured to release 314 the channel resources to the cluster head for common uses.

In an embodiment, prior releasing in step 316 channel resources to the cluster head, the releasing user terminal may transmit 314 a message to the group of user terminals indicating that channel resources are to be released to the cluster head. The message may be denoted as an Intra-Group Channel Release Notification similar as in step 304 but not for intra-group channel passing but triggering possible resource requests of the particular channel resources. That is, those group members who need those channel resources may try to request them from the cluster head in a regular fashion. In an embodiment, those group members who need those to-be-released channel resources indicated in the received Intra-Group Channel Release Notification may send an Intra-Group Channel Transfer Request on the to-be-released channel resources to the cluster head providing that the cluster head is aware that the releasing user terminal wants to release the not-needed channel resources within the same user group and starts monitoring those channel resources for possible Intra-Group Channel Transfer Request from the user group.

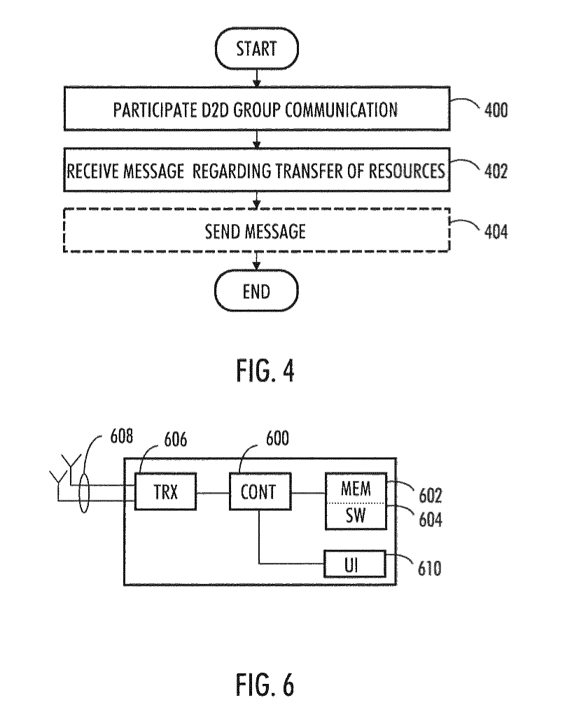

Let us next study further examples of the operation of a UT which is member of a user group conducting D2D group communication under control of a cluster head CH. The user terminal is able to receive resources from another user terminal of the group. FIG. 4 is a flowchart illustrating some examples. The user terminal which is able to receive resources may be denoted as the receiving user terminal.

In step 400, the receiving user terminal participates in a direct device-to-device communication with a group of user terminals. The user terminal may be either an active or a passive member.

In step 402, the receiving user terminal is configured to control the reception of a transfer message targeted to the group of user terminals, the message indicating that a user terminal has transferred at least part of the channel resources the user terminal used for direct device-to-device communication with the group of user terminals to the receiving user terminal of the group. The message may be denoted an Intra-Group Channel Transfer Indication.

In an embodiment, the receiving user terminal is in step 404, configured to determine that it has received the channel resources; and control the transmission of a confirmation message regarding the received of the channel resources. The confirmation message may be denoted an Intra-Group Channel Transfer Confirm. The receiving user terminal may be responsible for further pooling or distributing or releasing of the received resources.

The process ends.

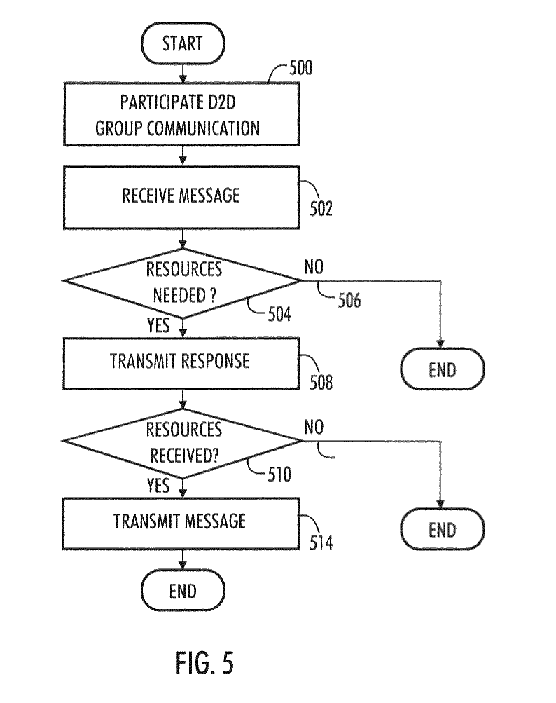

FIG. 5 is a flowchart illustrating another example of the operation of the receiving user terminal.

In step 500, the receiving user terminal participates in a direct device-to-device communication with a group of user terminals. The user terminal may be either an active or a passive member.

In step 502, the receiving user terminal is configured to control the reception of a first message from a releasing user terminal of the group indicating that at least part of the channel resources the releasing user terminal used for direct device-to-device communication with the group of user terminals are released.

In step 504, the receiving user terminal is configured to determine if channel resources are needed for direct device-to-device communication with the group of user terminals. If not 506, the process ends.

If resources could be received, the receiving user terminal is configured in step 508 to control the transmission of a response to the first message, the response comprising a request for the channel resources. The request may comprise the ID of the user terminal, and cause for the request (starting/updating of service/application, data buffer information), priority information or other data.

If the receiving user terminal is an active member with dedicated channel resources allocated to it the response may be sent on the dedicated channel resources.

In an embodiment, the response comprising the request may be sent via the cluster head. In this case the cluster head will receive and relay or re-broadcast the response for the releasing user terminal. This embodiment is especially applicable for passive group members which have no channel resources allocated for transmitting. This option also allows for the cluster head to know about the resources to be released in advance and therefore it may decide to reclaim it from the user group in a proactive or pre-emptive fashion.

In an embodiment, the receiving user terminal may use the to-be-released channel resources of the releasing user terminal as indicated in the first message to send the response in a contention based fashion. This option can also be considered as a resource-saving intra-group alternative to the previous cluster head assisted option, particularly applicable for passive UT member to request. To enable and enhance this option, the releasing user terminal may be allowed to indicate in the first message if and how this option is supported if not already pre-configured or hard-coded to UT members (timing information for sending the response on the to-be-released channel resources, indication whether this option is for only passive member or not, for example).

If the receiving user terminal receives the resources in step 510 by receiving a message indicating the reception) the user terminal may be configured in step 512 to control the transmission of a confirmation message regarding the received of the channel resources.

Above embodiments of the invention have been described assuming autonomous D2D communications. However, embodiments of the invention are not limited to such scenario it may be realized also in network-controlled D2D communications. In such cases many elements may be realized using possible assistance services from the network (the serving eNB). Referring to FIG. 1, the serving eNB 100 may be considered as a coordination point or master of all CHs operating inside the cell served by the eNodeB. In this regard, the serving eNB may be able to take over or provide assistance in any functions of CH towards members using cellular access.

FIG. 6 illustrates a simplified example of an apparatus in which embodiments may be applied. In some embodiments, the apparatus may be user terminal, user device or user equipment or a part of it capable of joining and communicating in a device-to-device cluster (and communicating with an eNodeB). The apparatus may comprise facilities (in a control unit, control circuitry or processor, etc.) to carry out functions of embodiments according to FIGS. 2, 3, 4 and/or 5. The facilities may be software, hardware or combinations thereof as described in further detail below.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 600 configured to control at least part of the operation of the apparatus. The control circuitry 600 is configured to execute one or more applications.

The apparatus may comprise a memory 602 (external and/or internal) for storing data or applications. Furthermore the memory may store software 604 executable by the control circuitry 600. The memory may be integrated in the control circuitry.

The apparatus comprises or is operationally coupled to at least one transceiver 606. The transceiver is operationally connected to the control circuitry 600. It may be connected to an antenna arrangement 608 comprising one more antenna elements or antennas.

The software 604 may comprise a computer program or at least part of it comprising program code means adapted to cause the control circuitry 600 of the apparatus to control a transceiver 606.

The apparatus may further comprise user interface 610 operationally connected to the control circuitry 600. The interface may comprise a (touch sensitive) display, a keypad, a microphone, and a speaker, for example.

If the apparatus is a releasing user terminal, the applications may cause the apparatus at least to participate in a direct device-to-device communication with a group of user terminals utilising dedicated channel resources, determine the ability of releasing all or some of the dedicated channel resources, select, from the group, at least one user terminal to which the channel resources are transferred and control the transmission of a transfer message to the group of user terminals, the message indicating the at least one user terminal the channel resources are transferred to.

If the apparatus is a receiving user terminal of a D2D group, the applications may cause the apparatus at least to control the transmission of a first message to the group of user terminals indicating that channel resources may be released, control the reception of responses to the first message from one or more user terminals of the group, the responses comprising requests for available channel resources, select, from the group, on the basis of the responses at least one user terminal to which the channel resources are transferred to and control the transmission of a transfer message to the group of user terminals, the message indicating the at least one user terminal the channel resources are transferred to.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described embodiments may be implemented as an electronic digital computer, or a circuitry which may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) one or more portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above. The distribution medium may be a non-transitory medium.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. The medium may be a non-transitory medium. On the other hand, the carrier may also be a photoelectrical and/or electrical carrier signal or a telecommunications signal.

Depending on the processing power needed, the computer program may be executed in a single electronic digital computer or it may be distributed amongst a number of computers.

An embodiment provides an apparatus, comprising: means for determining the possibility of releasing at least part of the dedicated channel resources used for direct device-to-device communication with a group of user terminals; means for selecting, from the group, at least one user terminal to which the at least part of the channel resources are transferred; and means for controlling the transmission of a transfer message to the group of user terminals, the message indicating the at least one user terminal the at least part of the dedicated channel resources are transferred to.

An embodiment provides an apparatus, comprising: means for controlling the reception of a transfer message targeted to the group of user terminals, the message indicating that a user terminal is transferring at least part of the dedicated channel resources the user terminal used for direct device-to-device communication with the group of user terminals to at least one other user terminal in the group.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1. An apparatus, comprising:
at least one processor; and
at least one memory including computer program code,
the at least one memory and the computer program code configured to, with the at least one processor, cause the apparatus at least to:
determine a possibility of releasing at least part of dedicated channel resources used for direct device-to-device communication with a group of user terminals;
select, from the group of user terminals, at least one user terminal to which the at least part of the dedicated channel resources are transferred; and
control a transmission of a transfer message to the group of user terminals, the transfer message indicating the at least one user terminal the at least part of the dedicated channel resources are transferred to.

2. The apparatus of claim 1, the at least one memory and the computer program code configured to, with the at least one processor, cause the apparatus, prior to transmitting the transfer message, further to:
control a transmission of a first message to the group of user terminals indicating that the at least part of the dedicated channel resources are releasable;
control a reception of responses to the first message from one or more user terminals of the group, the responses comprising requests for the at least part of the dedicated channel resources;
wherein the selection of the at least one user terminal is based on the responses.

3. The apparatus of claim 2, the at least one memory and the computer program code configured to, with the at least one processor, cause the apparatus further to:
control the transmission of the first message on the at least part of the dedicated channel resources.

4. The apparatus of claim 2, the at least one memory and the computer program code configured to, with the at least one processor, cause the apparatus further to:
specify in the first message the at least part of the dedicated channel resources which are released.

5. The apparatus of claim 2, the at least one memory and the computer program code configured to, with the at least one processor, cause the apparatus further to: control the transmission of the first message, the transmission using the dedicated channel resources to be released.

6. The apparatus of claim 2, the at least one memory and the computer program code configured to, with the at least one processor, cause the apparatus further to: control repetition of a transmission of the first message a predetermined number of times if a response to the first message is not received.

7. The apparatus of claim 2, the at least one memory and the computer program code configured to, with the at least one processor, cause the apparatus further to: release the at least part of the dedicated channel resources to a user terminal controlling the direct device-to-device communications, if responses to the first message are not received.

8. The apparatus of claim 7, the at least one memory and the computer program code configured to, with the at least one processor, cause the apparatus further to: prior to releasing the at least part of the dedicated channel resources to the user terminal controlling the direct device-to-device communications, control the transmission of a message to the group of user terminals indicating that the at least part of the dedicated channel resources are to be released to the user terminal controlling the direct device-to-device communications.

9. The apparatus of claim 2, wherein the responses to the first message comprise one or more reasons for the request for the at least part of the dedicated channel resources, the apparatus being further configured to select on the basis of the one or more reasons in the requests the at least one user terminal of the group to transfer the at least part of the dedicated channel resources to.

10. The apparatus of claim 1, the at least one memory and the computer program code configured to, with the at least one processor, cause the apparatus further to: receive from the at least one selected user terminal a confirmation message regarding the transfer of the at least part of the dedicated channel resources.

11. The apparatus of claim 1, the at least one memory and the computer program code configured to, with the at least one processor, cause the apparatus further to: include in the first message at least one of the following: identification (ID) of the releasing user terminal, identification (ID) of the targeted user group, details of the dedicated channel resources to be released, and a cause for the releasing of the resources.

12. An apparatus, comprising:
at least one processor; and
at least one memory including computer program code,
the at least one memory and the computer program code configured to, with the at least one processor, cause the apparatus at least to:
participate in a direct device-to-device communication with a group of user terminals; and
control the reception of a transfer message targeted to the group of user terminals, the message indicating that a user terminal is transferring at least part of dedicated channel resources the user terminal used for direct device-to-device communication with the group of user terminals to at least one other user terminal in the group.

13. The apparatus of claim 12, the at least one memory and the computer program code configured to, with the at least one processor, cause the apparatus further to, prior to receiving the transfer message:
control the reception of a first message from a user terminal of the group of user terminals indicating that the at least part of the dedicated channel resources the user terminal is using for direct device-to-device communication with the group of user terminals are released;
determine if channel resources for direct device-to-device communication with the group of user terminals are needed; and if so:
control the transmission of a response to the first message, the response including a request for the releasable dedicated channel resources.

14. The apparatus of claim 12, the at least one memory and the computer program code configured to, with the at least one processor, cause the apparatus further to:
determine that the at least part of the dedicated channel resources are to be used; and
control a transmission of a confirmation message indicating that the at least part of the dedicated channel resources are going to be used.

15. The apparatus of claim 13, the at least one memory and the computer program code configured to, with the at least one processor, cause the apparatus further to:
control a reception of a message targeted to the group of user terminals, the message indicating that the at least part of the dedicated channel resources are to be released to a user terminal controlling the direct device-to-device communications.

16. The apparatus of claim 15, the at least one memory and the computer program code configured to, with the at least one processor, cause the apparatus further to: control a transmission of a message to the user terminal controlling the direct device-to-device communications, the message including a request for the at least part of the dedicated channel resources.

17. The apparatus of claim 13, the at least one memory and the computer program code configured to, with the at least one processor, cause the apparatus further to:
participate in a direct device-to-device communication with the group of user terminals utilising dedicated channel resources;
control a transmission of a response to the first message on the dedicated channel resources.

18. The apparatus of claim 13, the at least one memory and the computer program code configured to, with the at least one processor, cause the apparatus further to:
control a transmission of a response to the first message on the dedicated channel resources indicated to be released.

19. The apparatus of claim 13, the at least one memory and the computer program code configured to, with the at least one processor, cause the apparatus further to:
control a transmission of a response to the first message on the channel resources reserved by the given user terminal for signalling purposes, the response being directed to the user terminal controlling the direct device-to-device communications.

20. A method, comprising:
determining a possibility of releasing at least part of dedicated channel resources used for direct device-to-device communication with a group of user terminals;
selecting, from the group, at least one user terminal to which the at least part of the dedicated channel resources are transferred; and
controlling a transmission of a transfer message to the group of user terminals, the transfer message indicating the at least one user terminal the at least part of the dedicated channel resources are transferred to.

21. The method of claim 20, prior to transmitting the transfer message, further comprising:
controlling a transmission of a first message to the group of user terminals indicating that the at least part of the dedicated channel resources are releasable;
controlling a reception of responses to the first message from one or more user terminals of the group, the responses comprising requests for the at least part of the dedicated channel resources;
wherein the selection of the at least one user terminal is based on the responses.

22. The method of claim 20, further comprising:
controlling the transmission of the first message on the at least part of the dedicated channel resources.

23. The method of claim 20, further comprising:
specifying in the first message the dedicated channel resources which are released.

24. The method of claim 20, further comprising:
controlling the transmission of the first message, the transmission using the dedicated channel resources to be released.

25-30. (canceled)

31. A method, comprising:
controlling reception of a transfer message targeted to a group of user terminals, the transfer message indicating that a user terminal is transferring at least part of dedicated channel resources the user terminal used for direct device-to-device communication with the group of user terminals to at least one other user terminal in the group.

32. The method of claim 31, prior to receiving the transfer message, further comprising:
controlling reception of a first message from the user terminal of the group of user terminals indicating that at least part of the dedicated channel resources the user terminal is using for direct device-to-device communication with the group of user terminals are released;
determining if channel resources for direct device-to-device communication with the group of user terminals are needed; and if so
controlling a transmission of a response to the first message, the response including a request for the releasable dedicated channel resources.

33. The method of claim 31, further comprising:
determining that the at least part of the dedicated channel resources are to be used; and
controlling a transmission of a confirmation message indicating that the at least part of the dedicated channel resources are going to be used.

34-42. (canceled)
